(19) United States
(12) Patent Application Publication
(10) Pub. No.: US 2007/0034249 A1
(43) Pub. Date: Feb. 15, 2007

(54) Floating solar powered electronic device and system

(76) Inventors: Matthew A. Romano, Hillsborough, NJ (US); Andrew S. Trabucco, Freehold, NJ (US)

Correspondence Address: Kenneth P. Glynn, 24 Mine Street, Flemington, NJ, 08822, US

(21) Appl. No.: 11/333,868

(22) Filed: Jan. 17, 2006

Related U.S. Application Data
(63) Continuation-in-part of application No. 11/202,787, filed on Aug. 12, 2005.

(51) Int. Cl. H02N 6/00

(52) U.S. Cl. 136/244; 136/291

(57) ABSTRACT

A floating solar powered apparatus includes a main housing with an electrically operated component, with an at least translucent portion for transmittal of sunlight into the main housing during daylight hours. The main housing is water impervious and has at least two lateral sections that cooperate to open and close to clamp a line or rope. The electronically operated component contained within the main housing and it is selected from the group consisting of a detector, an alarm, a radio, a light source for illumination, and combination thereof. There is also a power supply and appropriate connections connected to the electronically operated component(s) contained within the main housing that includes at least one solar cell.

### REFERENCE TO RELATED PATENT APPLICATIONS

This application is a continuation-in-part of U.S. utility patent application Ser. No. 11/202,787, entitled “Floating Solar Powered Light Apparatus, System and Ladder Accesssory” filed on Aug. 12, 2005 by the same inventors herein.

### BACKGROUND OF THE INVENTION

1. Field of the Invention

The present invention relates to solar powered electronic devices, e.g. a light apparatus, a radio apparatus, a sensor, an alarm, combination apparatus, such as a light and radio, etc. Each device has a floatable, water sealed main body and has a clamping feature for a rope or other line for attachment thereto. The present invention also involves systems that are based on a plurality of solar powered electronic devices, i.e. a string of the apparatuses on a rope or other line. Some present invention alternative systems include present invention floating solar powered devices with various different electronically operated components, alone, in combination or in series or sequence.

2. Information Disclosure Statement

The following prior art is representative of the state of the art in the fields of lighting and floats:

U.S. Pat. No. 4,809,458 describes a self-luminous buoy thereof comprises a solar generator, a light-emitting element which emits the light by the energy supplied from the storage battery and an energy control means which permits the supply of the electrical energy from said storage battery and an energy control means which permits the supply of the electrical energy from said storage battery to said lighting-emitting element only when illumination drops below a predetermined level.

U.S. Pat. No. 5,231,781 describes an illuminated float comprises a plurality of solar generators, a storage battery for storing therein the electrical energy generated by the solar generator, a light-emitting element which emits the light by the energy supplied from the storage battery, a homing device which emits a high-frequency beacon displayed on the ships display screen, and an energy control means which permits the supply of electrical energy from the storage battery to the light-emitting element and the homing device only when ambient illumination drops below a predetermined level.

U.S. Pat. No. 5,782,552 describes a light assembly comprising a light-emitting diode (LED), a rechargeable capacitor to energize the diode, and a solar cell to recharge the capacitor. Preferably, there is circuitry to enable charging of the capacitors and circuitry to enable use of the solar cell as a photo sensor to selectively energize the LED when the ambient light is below a pre-determined level, and to stop energizing the LED when the ambient light is above a pre-determined level.

U.S. Pat. No. 6,402,338 B1 describes an enclosure illumination system is provided. The enclosure illumination system is mounted on an enclosure. The enclosure illumination system includes a solar battery, a light element, and a motion sensor. When external light impinges upon solar battery, light is prevented from actuating. When solar battery is not exposed to external light, for example, at night, light may be actuated by signals transmitted by sensor.

Notwithstanding the prior art, the present invention is neither taught nor rendered obvious thereby.

### SUMMARY OF THE INVENTION

The present invention relates to a floating solar powered apparatus or device that includes a main housing, the main housing having an at least translucent portion for transmittal of sunlight into the main housing during daylight hours. It may be at least partially transparent or translucent, and may have one or more colored translucent areas and/or one or more transparent areas. The main housing is water impervious and has at least two lateral sections or components that may be separate from one another or hinged to one another and it also has at least one rope clamping means connected to the two sections, e.g. one rope attachment orifice that is created when the at least two sections are connected to one another, along with a securing mechanism for the at least two sections, e. g, a clasp, lock, interlock, strap or other securing mechanism that will keep the at least two sections closed once attached to a rope or other line.

The electronically operated component contained within the main housing is selected from the group consisting of a detector, an alarm, a radio, a light source for illumination, and combination thereof. There is also a power supply, e.g. a battery or equivalent electric power storage means, and appropriate connections connected to the electronically operated component(s) contained within the main housing that includes at least one solar cell. The at least one solar cell is located in the at least translucent portion of the main housing. In some preferred embodiments, the at least translucent portion is transparent.

Because there are at least two sections to the main housing, the devices may have all of its components in one section, or they may be divided up into the at least two sections, in which case interconnectors, such as plugs or contacts may be included to complete circuits or connections when the sections are closed (connected). Alternatively, the wiring and connections could be flexible and/or of extended length for hinged embodiments so as to maintain connection in both the open and closed positions and hence eliminate the need for sectional wiring connectors.

The present invention floating solar powered apparatus main housing may have an external shape when its sections are closed (connected to one another) selected from the group consisting of an ovoid, an ellipsoid, a flat-ended cylinder, a round-ended cylinder, and a sphere, or the main housing may have an external shape selected from the group consisting of flat-ended polygons and round ended polygons. Any shape is useable as long as it presents the solar cell(s) to the sunlight.

In some preferred embodiments of the present invention, the main housing has a center point and has the at least one rope attachment orifice passing through the center point.

In some embodiments, the electronically operated component is a light source. The floating solar powered light apparatus light source may be at least one light emitting diode.

In some present invention floating solar powered light apparatuses, the light source is a plurality of light emitting diodes.

The present invention floating solar powered apparatus rope attachment orifice may have locking mechanism to inhibit movement between the apparatus and a rope that is passed through the rope attachment orifice.

In some embodiments, the floating solar powered apparatus solar cell(s) is adapted to receive sunlight over an arcuate area having an angle of at least 90 degrees. In other embodiments, the solar cell is adapted to receive sunlight over an arcuate area having an angle of at least 180 degrees. In yet other embodiments, the solar cell is adapted to receive sunlight over an arcuate area having an angle of at least 320 degrees. On many preferred embodiments, the solar cell(s) has a 360 degree exposure.

The electronically operated components may be a receiving radio with public or devoted frequency(ies) or a two way radio communication device. The electronically operated components may be a water characteristic sensing device that senses at least one characteristic selected from the group consisting of pH, chlorine level, and temperature. This is particularly advantageous for Jacuzzis, swimming pools, and ponds. Another possible present invention component is an alarm that sends a signal when a preset condition is detected. This could involve motion sensing, temperature sensing, chlorine sensing, pH, or other sensing. The component could be a wireless communications component with a keypad capability, a cell phone, or PDA.

In the present invention system, a plurality of floating solar powered apparatuses are strung together with a flexible line, e.g. a rope or similar line. The individual apparatuses of the plurality of floating solar powered apparatuses. May all be the same, or may be any combination of those described above. The line, rope, cord or other flexible line may have anchoring means located at each end for connection to an anchor member, such as an eyelet, hook, weight, pipe post most or any other anchoring device.

While the present invention device is floatable, it does not need to be used in a floating environment. Because it is floatable, it is inherently waterproof and may be used in any other environment, e.g. as most lighting, deck lights, outdoor ornaments, etc. The electronic components may, therefore, be chosen from those stated above, and/or may include weather characteristics sensing, e.g. humidity, wind, temperature.

### BRIEF DESCRIPTION OF THE DRAWINGS

The present invention should be more fully understood when the specification herein is taken in conjunction with the drawings appended hereto wherein:

FIG. 1 illustrates a side view of one embodiment of a present invention floating solar powered light apparatus;

FIGS. 2A, 2B and 2C show an end view, a closed perspective view and an end open view, respectively of the present invention apparatus shown in FIG. 1;

FIG. 3 shows a schematic diagram of one possible functional arrangement for a present invention apparatus;

FIGS. 4A and 4B show open and closed end views, respectively, of another preferred embodiment of the present invention apparatus;

FIGS. 5, 6, 7 and 8 illustrate other preferred embodiments of the present invention apparatus having different shapes and section connecting mechanisms;

FIG. 9 illustrates a side view of an alternative embodiment present invention apparatus;

FIG. 10 illustrates a side view of an alternative embodiment present invention apparatus with additional features for sensing water properties or other characteristics;

FIG. 11 illustrates a side view of an alternative embodiment present invention apparatus with ancillary electronic components;

FIG. 12 shows a floating solar powered system;

FIG. 13 shows a partial detailed view of the present invention system shown in FIG. 12; and,

FIG. 14 illustrates a side view of an alternative present invention water sealed solar powered apparatus and FIG. 15 illustrates a side view of a present invention system using a plurality of FIG. 14 type devices.

### DETAILED DESCRIPTION OF THE PRESENT INVENTION

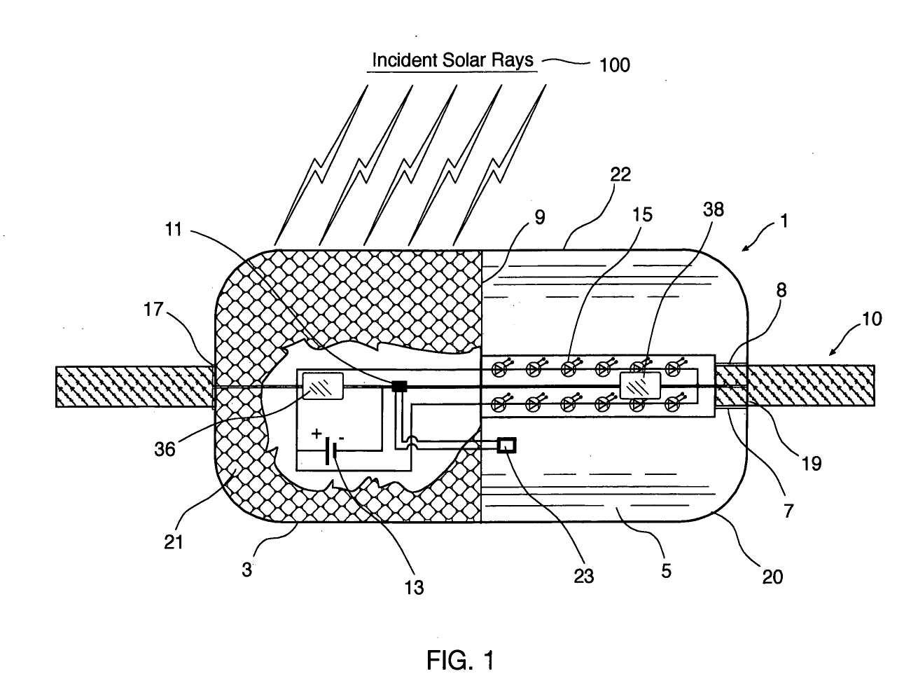

FIG. 1 illustrates a side view of one embodiment of a present invention floating solar powered light apparatus 1. Apparatus 1 includes a main housing which is made up of a left functional portion 3 and a right functional portion 5 meeting at seam 9. These portions from left to right, may be permanently attached to one another (heat weld, glued, one way ratchet screwed, etc.) or removably attached (snap fit, screw, seal, etc) in halves or other sections consisting of the lateral sections. The main housing has two lateral sections that are hingedly connected to one another. These two lateral sections are, in this view, lower section 20 and upper section 22. They have connecting hinges in the rear and snap latches 36 and 38 as shown. These open and close and, when closed, fit together to form a water-sealed device that clamps onto a rope such as rope 10. When closed, the two sections form a rope receiving orifice with orifice ends 17 and 19. In this embodiment, it is the combination of the hinges, clasps and orifice that together form a rope clamping means. at seam 9. When they are connected or closed, sections 3 and 5 have an end view donut configuration, and create a watertight, water impervious floatable member.

Referring further to FIG. 1, right area portion 5 is at least partially translucent, meaning that part is either translucent or transparent, or a combination of both. Left area portion 3 is partially or fully coated with or contains solar cell component(s) 21. The solar cell component(s) 21 has exposure to incidental solar rays 100 for activation of the solar cell component(s) 21 to create electrical power. The generated electrical power is received by battery or equivalency 13 and regulated by processor 11. In this embodiment, there is an optional on/off or momentary pulse switch 23 to turn on/off or change the light sequence or light color array 15. These lights could be any type that would function in the content of the present invention, such as flat lights, bulbs, LCDA, and in this case, are LED's. These could be white lights, colored lights, or a combination or both.

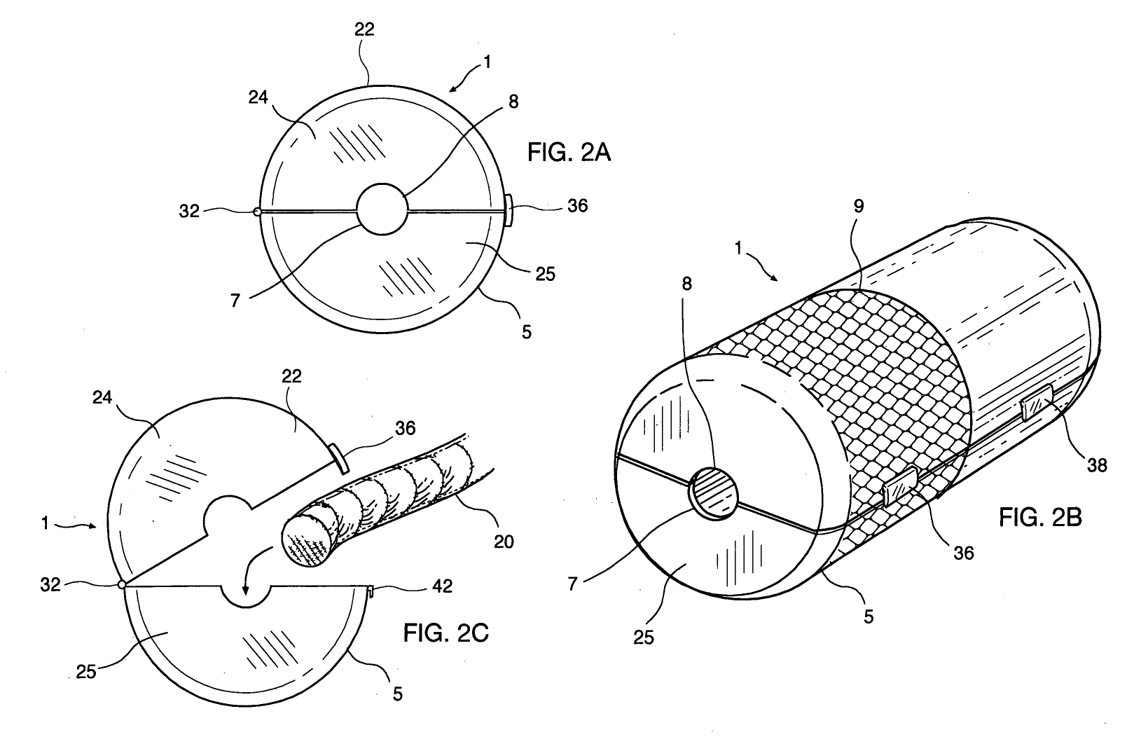

FIGS. 2A, 2B and 2C show an end view, a closed perspective view and an end open view, respectively, of present invention apparatus 1 shown in FIG. 1. Identical parts to FIG. 1 are identically numbered and some details and reference numerals are excluded from these Figures, as they are unnecessary to the salient features illustrated here.

In FIG. 2A, device 1 has a lower orifice section 7 and an upper orifice section 8 form the rope clamping orifice when the two sections are closed in this Figure and in FIG. 2B. FIG. 2C shows device 1 open and ready to be clamped to nylon cord 20. The cord 20 is nested into the orifice sections and the device is closed. The closing both keeps the device on the cord 20 and makes it watertight all around.

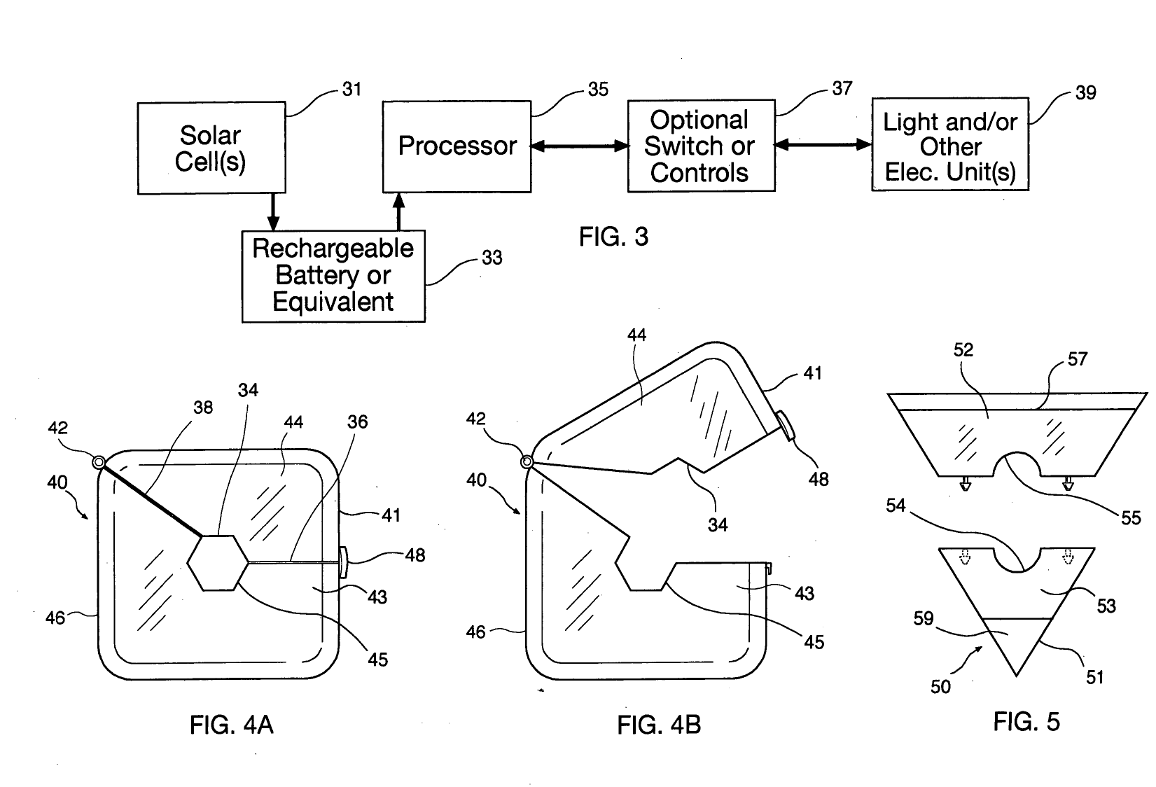

FIG. 3 shows a schematic diagram of one possible functional arrangement for a present invention apparatus for lighting and/or other electronic functionalities. In FIG. 3, solar cell(s) 31 are connected to a rechargeable battery or equivalent 33. Processors 35 acts as a controller and may include such features as voltage regulations and timed pulsing. Processor 35 may be self-regulating or may have an optional switch or control 37 for controlling light and/or other unit(s) 39.

In FIG. 4A and FIG. 4B, present invention apparatus 40 is shown in the closed and opened positions, respectively. The device is similar to and functions similarly to apparatus 1 of FIG. 1, except that it has four flat sides, such as side 41 (with small arc rounded corners) and flat ends, such as end 43. Also, the rope attachment orifice is hexagonal and the cut of the sections is angled. Thus, hinge 42 is on an upper corner and upper section 44 is less than half of the device, with edges 36 and 38, as shown. Bottom section 46 has an orifice portion 45 and top section 44 has an orifice section 34, that, when closed, form an orifice for a line, rope, cord, staff, rod or other elongated member to which it may be attached.

FIGS. 5, 6, 7 and 8 illustrate other preferred embodiments of the present invention apparatus.

FIG. 5 shows an end view of another present invention apparatus 50 with a trapezoidal upper section 52 and a triangular lower section 53 that are separate pieces and include electrical path connectors and male/female snap-in clamping mechanisms. They have half circle orifice portions 54 and 55, and, when snapped together, form a triangular cross-section having three equal sides, such as side 51, with a weighted bottom 59, a top flat solar panel 57 and a line attachment orifice.

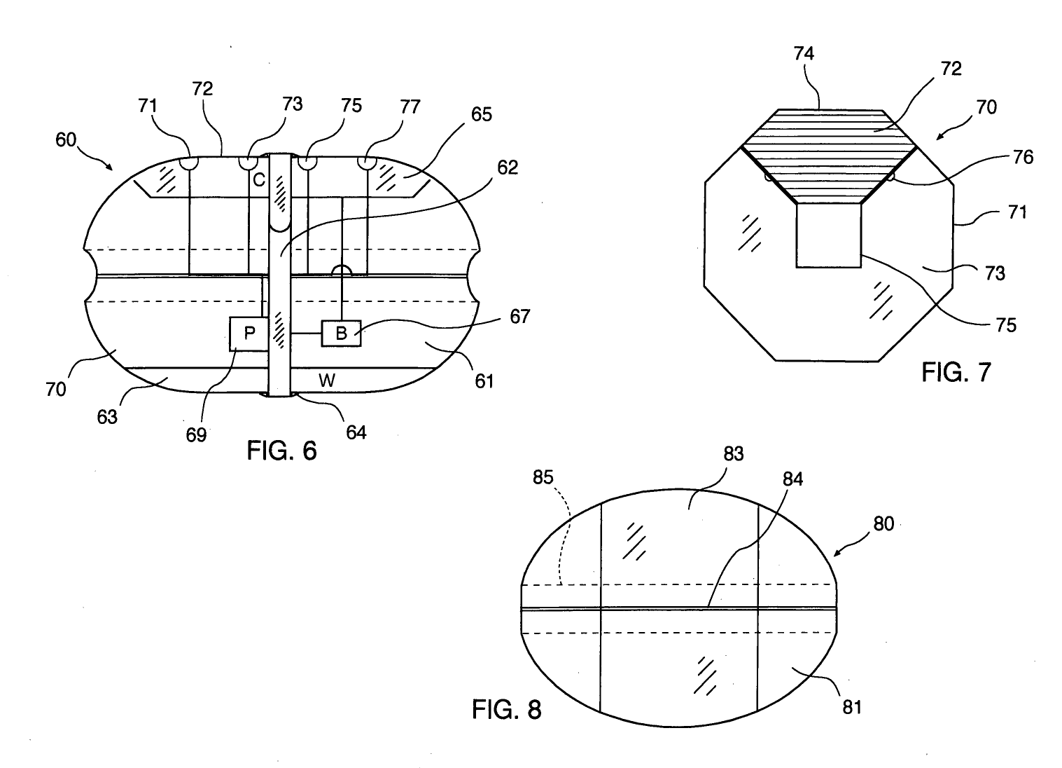

FIG. 6 shows a side view of a cylinder present invention apparatus 60 with hemispherical ends and a central rope orifice, as shown. It has two sections 70 and 72 that nest together and are kept together with a band or strap 62. This band or strap is elastic, e.g. a rubber or other material band, or it may be inelastic with affixing means such as a buckle or hook and loop velcro connection or the like. There are ramps, such as ramp 64, to keep the band or strap from slipping off the device main housing. In this embodiment, there are solar cells 65, battery 67, processor 69 and lights 71, 73, 75, and 77. The lights are positioned in clear areas surrounded by solar cell material and the device is weighted by weight 63 at bottom 61. This weight will maintain floating device 60 so that solar cells 65 are always facing the sky to optimize solar charge with minimal solar cell material.

FIG. 7 shows an end view of another present invention apparatus 70 with a hexagonal cross-section having six equal sides, such as side 71, and has a top flat solar panels, e g. panel 72, and a flexible line attachment orifice 75 formed by closure of its upper and lower sections 74 and 75. Snaps, such as snap 76 keep the sections clamped together and watertight.

FIG. 8 shows a side view of another present invention apparatus 80 with an egg shape, and has a round solar panel 93 and a line attachment orifice 95 when upper section 83 and lower section 81 are snapped together by snap fit seam 84.

Each of the foregoing Figures showing various shapes for present invention apparatuses may contain any or all of the heretofore disclosed electrically operated components.

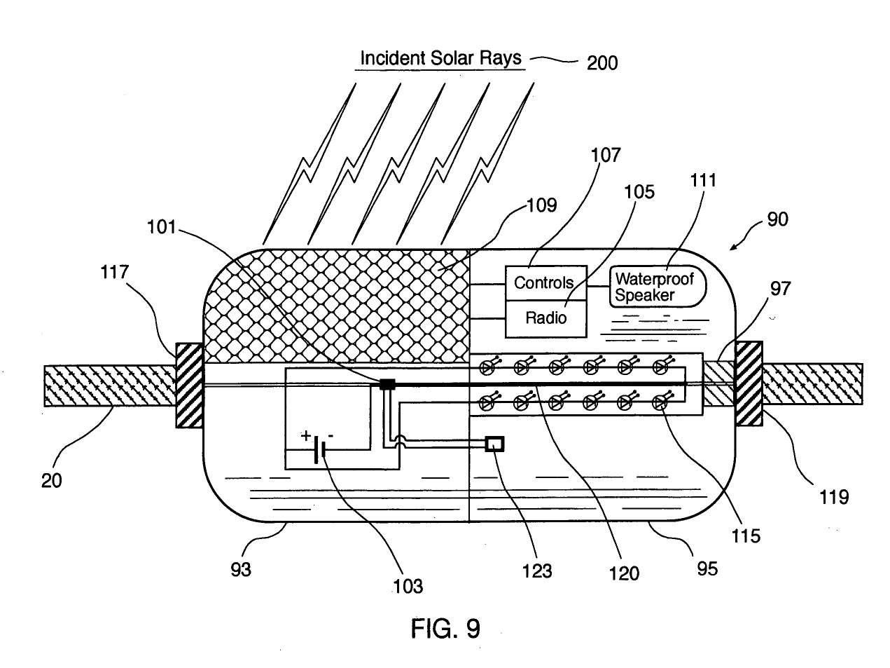

FIG. 9 illustrates a side view of another embodiment of a present invention floating solar powered apparatus 90 that utilizes both lights and a radio. Apparatus 90 includes a main housing which has upper and lower lateral sections that open and close at seam 120 in accordance with any of the mechanisms described elsewhere herein, each section of which is made up of a left section 93 and a right section 95. These fit together at a center seam and may be permanently attached to one or removably attached, as discussed above. The sections 93 and 95 have an end view donut configuration that, when the upper and lower sections are connected, create a watertight, water impervious floatable member similar to apparatus 1 of FIG. 1.

In FIG. 9, section rope attachment orifices, such as orifice 97, are coincidental and form a continuous rope attachment orifice for rope 20. Tight grip annular plugs 117 and 119 hold the apparatus 90 in position on the rope to prevent sliding. As is shown below, a string of these apparatuses may be used and spacing is both aesthetically pleasing and will maximize light usage.

Right section 95 is at least partially translucent to allow the lights of light array 115 to shine through at night. Left section 93 is partially or fully coated with or contains solar cell component 109. The solar cell component 109 has exposure to incidental solar rays 200 for activation to create electrical power. The generated electrical power is received by battery 103 and regulated by processor 101. In this embodiment, there is an optional on/off or momentary pulse switch or control 123 to turn on/off the light array 115 and the radio 105. These lights could be any type that would work, and in this case, are LED's. These could be white lights, colored lights, or a combination or both. The radio 105 may be an AM/FM radio, and X-radio or a two way communicator, such as walkie talkies. The radio 105 has controls 107, such as wavelength, station, volume and/or other controls, and may have an optional antenna. There is also a water proof speaker 111, that could also be a receiver in the case of two way radios. In some other embodiments, the radio 105 could be a cell phone or PDA or other communicator and controls 107 could be or include a telephone or other key pad.

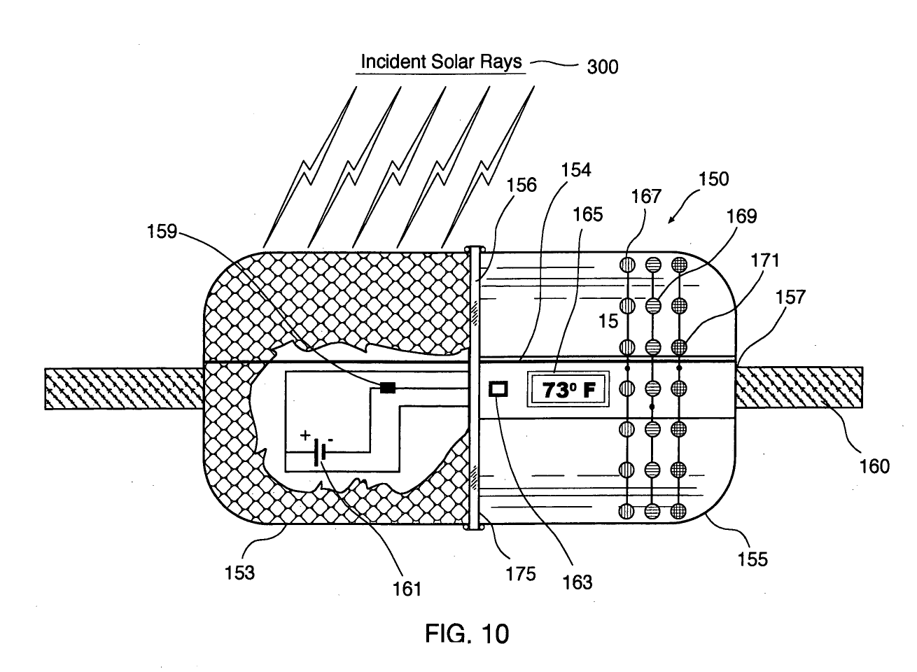

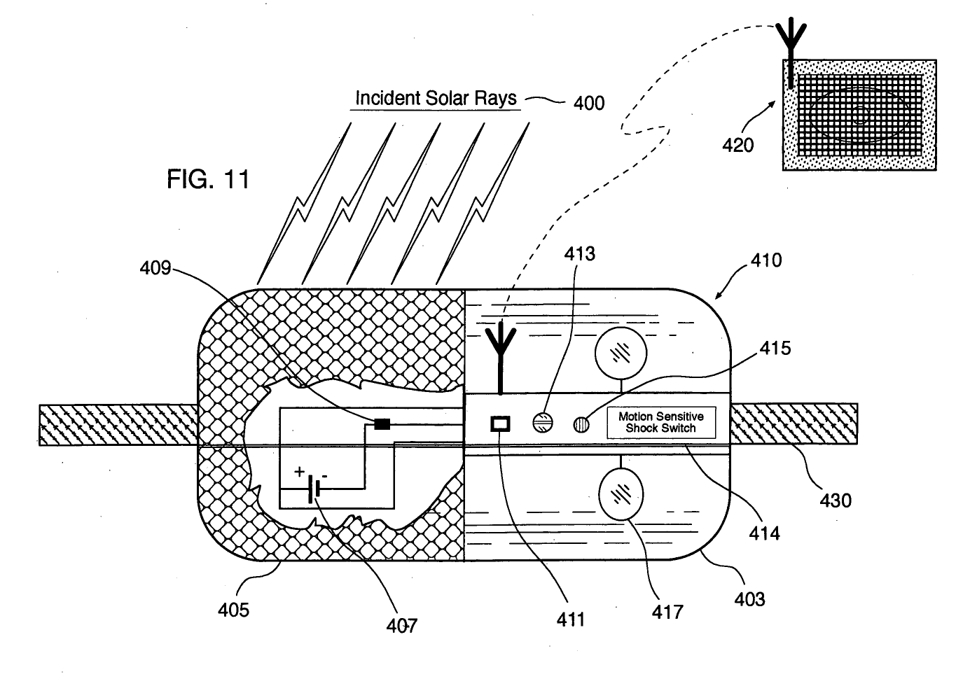

FIG. 10 illustrates a side view of an alternative embodiment present invention apparatus 150 with additional features for sensing water characteristics. Apparatus 150 includes a main housing which has upper and lower lateral sections that open and close at seam 154 in accordance with any of the mechanisms described elsewhere herein, each section of which is made up of a left section 153 and a right section 155. These fit together at a center seam 154 and may be permanently attached to one another or removably attached, as discussed above. Clamp ring 156 holds the sections together, as shown. The sections 153 and 155, similar to those described above, have an end view donut configuration that, when connected, create a watertight, water impervious floatable member similar to apparatus 1 of FIG. 1.

In FIG. 10, section rope attachment orifice 157 is a continuous rope attachment orifice for rope 160. Tight grip gluing or rubber fittings hold the apparatus 150 in position on rope 160 or flexible line to prevent any sliding. Right section 155 is at least partially exposed to allow the pH sensors 167, chlorine sensors 169 and temperature sensors 171 to operate. Display 165 may be dormant, may cycle through different readings or may be set or changed with control button 163. Left section 153 is partially or fully coated with or contains solar cell component(s) as shown. The solar cell component(s) has exposure to incidental solar rays 300 for activation to create electrical power. The generated electrical power is received by battery 161 or equivalent electrical power source, and regulated by processor 159. In this embodiment, there is an optional on/off feature built into control button 163. A user will use this present invention apparatus 150 to instantly see readouts for a swimming pool, jacuzzi, designer pond or the like and use the information to add chemicals or otherwise rely upon the data.

FIG. 11 illustrates a side view of an alternative embodiment present invention apparatus 410 with ancillary electronic components. Apparatus 410 includes a main housing which has upper and lower lateral sections that open and close at seam 414 in accordance with any of the mechanisms described elsewhere herein, each section of which is made up of a left section 405 and a right section 403. These screw together at a center seam and may be permanently attached to one or removably attached, as discussed above. The sections 403 and 405, similar to those described above, have an end view donut configuration that, when connected, create a watertight, water impervious floatable member similar to apparatus 1 of FIG. 1.

In FIG. 11, a flexible line attachment orifice is a continuous attachment orifice for nylon cord 430 or similar flexible line. Tight grip gluing or rubber fittings or manually created, as-you-go knots at each end of the apparatus to hold the apparatus 430 in position to prevent any sliding or bunching.

Right section 403 is at least partially exposed (transparent) to allow the motion or sound sensors 413, 415 and 417 to operate. The antenna in the apparatus signals to a remote antenna 420 to create an audio or other signal combined or separate visual or printout or audio, e. g. a flashing light or a buzzer or siren). The device is turned on/off with switch 411. Left section 403 is partially or fully coated with or contains solar cell component(s) as shown. The solar cell component(s) has exposure to incidental solar rays 400 for activation to create electrical power. The generated electrical power is received by battery or other storage cell 407 and is regulated by processor 409. A user will use this present invention apparatus 410 to instantly detect unwanted, unauthorized or dangerous activity at a pool, jacuzzi, pond, boat or other area and take appropriate action, e. g. save a drowning child or pet or deter an intruder.

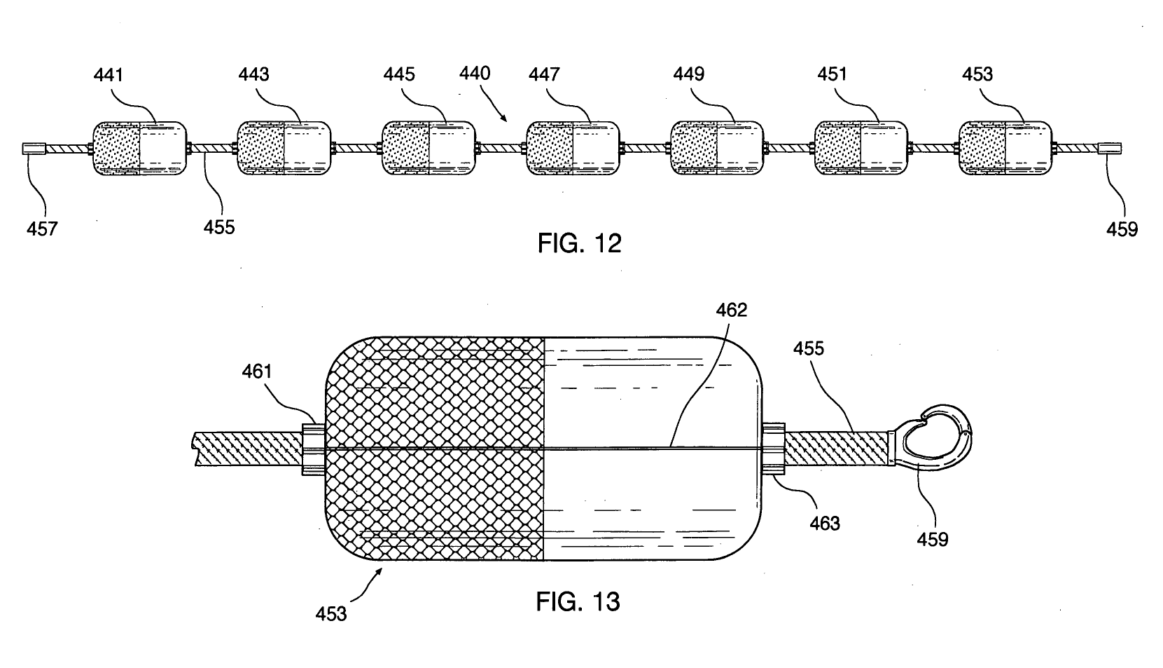

FIG. 12 shows a present invention floating solar powered light system 440 with a plurality of present invention apparatuses 441, 443, 445, 447, 449, 451 and 453 evenly strung along line 455. These apparatuses may be any of the above embodiments or others that would be variations thereof. End attachment means 457 and 459 may be any rope attachment means, such as hooks, clips, etc. for stringing the system across a pool or other area.

FIG. 13 shows a partial detailed view of the system described immediately above. There are a plurality of light devices such as apparatus 453 with circular screw type clamps 461 and 463 cooperating with section seating seam 462. Also shown in this Figure are rope 455 and end clip 459.

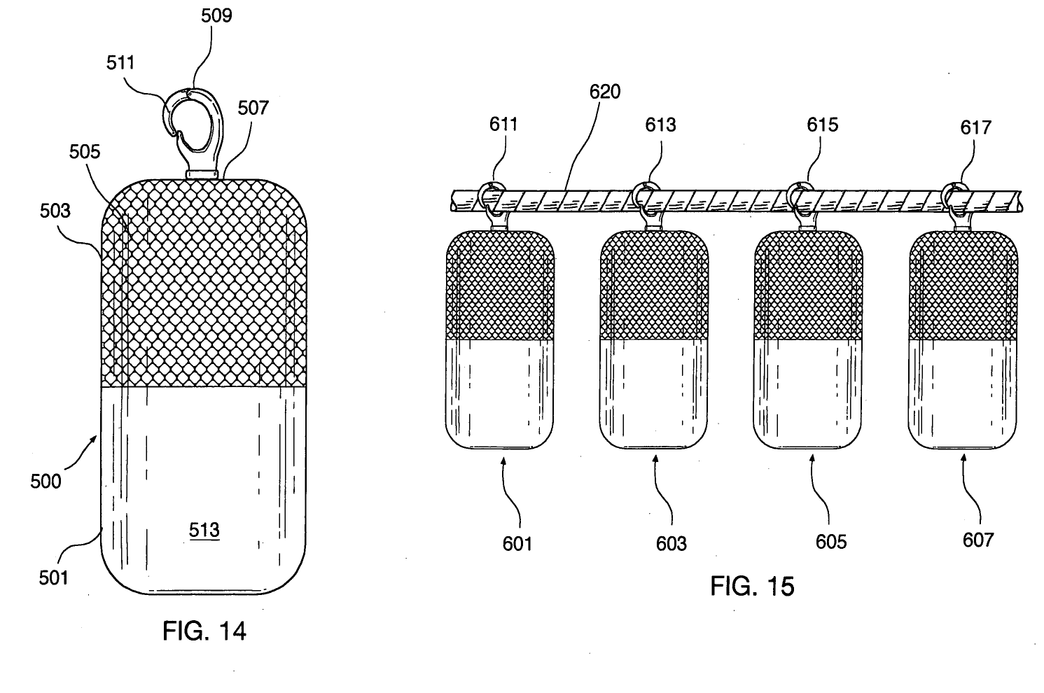

FIG. 14 illustrates a side view of a present invention water sealed solar powered light apparatus 500 with lower section 501 and upper section 503. Solar cell 505 is located on the top section and the other internal components are in the lower section and may be any of the types described elsewhere herein. Top area 507 has a clip 509 with a spring latch element 511 connected to it for easy attachment to anything that it will fit around. FIG. 15 shows a present invention system having a plurality of similar apparatuses 601, 603, 605 and 607 that are attached to cable 620 at their clips 611, 613, 615 and 617 respectively. In the alternative, these or any of the other present invention apparatuses could be connected to pool ropes, patio ropes, boat or ship lines, ropes cables and rails or any other thing to which they may be connected in accordance with the teachings herein.

Obviously, numerous modifications and variations of the present invention are possible in light of the above teachings. For example, the patent invention devices could be wirelessly connected to any other wireless device and/or to each other and any data collected could be sent out to a server or other transmission means to collect data. Likewise, incoming signals could affect, alter or otherwise control the device, such as reset parameters, clocks, locations, set off alarms, input new data for storage, etc. In other words, the device could also function as a wireless computer, PDA or other communications device. The devices could be connected to a GPS system and be used, at least in part for location, wave movement or the like. It is therefore understood that within the scope of the appended claims, the invention may be practiced otherwise than as specifically described herein.

What is claimed is:

1. A floatable solar powered electronic device, which comprises:
(a) a main housing, said main housing having an at least translucent portion for transmittal of sunlight into said main housing during daylight hours, said main housing being water impervious, said main housing having at least two lateral sections and having a rope clamping means connected to said two lateral sections;
(b) an electronically operated component contained within the main housing and selected from the groups consisting of a detector, an alarm, a radio, a light source for illumination, and combination thereof; and,
(c) a power supply and appropriate connections connected to said electrically operated component contained within said main housing and including at least one solar cell, said at least one solar cell being located in said at least translucent portion of said main housing.

2. The floating solar powered electronic device of claim 1 wherein said electrically operated component is said light source.

3. The floating solar powered electronic device of claim 1 wherein said main housing at least two lateral sections has a combined external shape selected from the group consisting of an ovoid, an ellipsoid, a flat-ended cylinder, a round ended-cylinder, and a sphere.

4. The floating solar powered electronic device of claim 1 wherein said main housing at least two lateral sections has a combined external shape selected from the group consisting of flat-ended polygons and round-ended polygons.

5. The floating solar powered electronic device of claim 1 wherein said main housing has two lateral sections.

6. The floating solar powered electronic device of claim 5 wherein said two lateral sections are symmetrical.

7. The floating solar powered electronic device of claim 2 wherein said light source is at least one light emitting diodes.

8. The floating solar powered electronic device of claim 1 wherein said rope clamping means is selected from the group consisting of hine-and-latch, snap lock, screws, belt and band.

9. The floating solar powered electronic device of claim 1 wherein said at least one solar cell is adapted to receive sunlight over an arcuate area having an angle of at least 90 degrees.

10. The floating solar powered electronic device of claim 1 wherein said at least one solar cell is adapted to receive sunlight over an accurate area having an angle of at least 180 degrees.

11. The floating solar powered electronic device of claim 1 wherein said at translucent portion is transparent.

12. The floating solar powered electronic device of claim 1 wherein said at least translucent portion is at least partially colored with a color selected from the group consisting or red, green, yellow, blue, and orange.

13. The floating solar powered electronic device of claim 1 where in said electronically powered component is a radio.

14. The floating solar powered electronic device of claim 1 where in said electrically powered component is a water characteristic sensing device that senses at least one characteristic selected from the group consisting of pH, chlorine level, and temperature.

15. The floating solar powered electronic device of claim 1 where in said electronically powered component is an alarm that send a signal when a present condition is detected.

16. The floating solar powered electronic device of claim 1 where in said electronically operated component is a wireless communications component.

17. A floating solar powered electronic device system, comprising:
(I.) a plurality of floating solar powered apparatuses, each of which includes:
(a) a main housing, said main housing having an at least translucent portion for transmittal of sunlight into said main housing during daylight hours, said main housing being water impervious, said main housing having at least two lateral sections are having a rope clamping means connected to said two lateral sections;
(b) an electronically operated component contained within the main housing and selected from the groups consisting of a detector, an alarm, a radio, a light source for illumination, and combination thereof; and,
(c) a power supply and appropriate connections connected to said light, and,
(II.) a flexible line running through said at least two lateral sections of each of said plurality of apparatuses.

18. The floating solar powered electronic device system of claim 17 which further includes anchoring means located at each end of said flexible line for connection to an anchor member.

19. The floating solar powered electronic device of claim 1 wherein said at least two lateral sections are hingedly connected to one another.

20. The floating solar powered light apparatus of claim 1 wherein said at least two lateral sections are separate components adapted to connect to one another.
